(19) United States
(12) Patent Application Publication
(10) Pub. No.: US 2008/0098304 A1
(43) Pub. Date: Apr. 24, 2008

(54) Methods and systems for prompting users of computing devices

(76) Inventors: Daryl David Coutts, Edmonton (CA); Stephen Harrison Johnston, Calgary (CA)

Correspondence Address: Daryl D. Coutts, Suite 207, 11103 84 Ave, Edmonton, AB, T6G 2X4, CA

(21) Appl. No.: 11/987,138

(22) Filed: Nov. 28, 2007

Related U.S. Application Data
(60) Provisional application No. 60/861,414, filed on Nov. 29, 2006.
(60) Provisional application No. 60/907,787, filed on Apr. 17, 2007.
(60) Provisional application No. 60/924,347, filed on May 10, 2007.
(60) Provisional application No. 60/924,575, filed on May 21, 2007.
(60) Provisional application No. 60/929,090, filed on Jun. 12, 2007.
(60) Provisional application No. 60/929,463, filed on Jun. 28, 2007.
(60) Provisional application No. 60/929,618, filed on Jul. 5, 2007.

(51) Int. Cl. G06F 3/00; G06F 3/048

(52) U.S. Cl. 715/704; 715/779

(57) ABSTRACT

Systems and methods for prompting a user of a computing device on a scheduled basis and interpreting the user's responses to the prompting, are described.

### CROSS REFERENCE TO RELATED APPLICATIONS

This application claims the benefit of priority under 35 USC 119(e) to U.S. Provisional Application No. 60/861,414, filed Nov. 29, 2006, entitled “SYSTEM FOR DELIVERING VIDEO ADS TO HANDHELD DEVICES”; U.S. Provisional Application No. 60/907,787, filed Apr. 17, 2007, entitled “METHODS AND SYSTEMS FOR PROMPTING USERS OF COMPUTING DEVICES”; U.S. Provisional Application No. 60/924,347, filed May 10, 2007, entitled “METHODS AND SYSTEMS FOR PROMPTING USERS OF COMPUTING DEVICES”; U.S. Provisional Application No. 60/924,575, filed May 21, 2007, entitled “METHODS AND SYSTEMS FOR PROMPTING USERS OF COMPUTING DEVICES”; U.S. Provisional Application No. 60/929,090, filed Jun. 12, 2007, entitled “SYSTEMS AND METHODS FOR ADVERTISING”; U.S. Provisional Application No. 60/929,463, filed Jun. 28, 2007, entitled “SYSTEMS AND METHODS FOR INFORMATION PRESENTATION”; and U.S. Provisional Application No. 60/929,618, filed Jul. 5, 2007, entitled “ADVERTISING INTERMEDIATION SERVER”, all of which are incorporated herein by reference in their entirety.

### TECHNICAL FIELD

The invention relates to prompting users of computing devices on a scheduled basis and taking actions based on the user's responses to the prompts. The invention also relates to playing media files on computing devices.

### BACKGROUND OF THE INVENTION

Many people today use handheld devices to organize their busy schedule, get information from the internet and communicate with their friends. A problem with handheld devices though is their high cost.

Advertisers today enjoy excellent exposure on two “screens”—the TV screen and the desktop computer screen. Advertisers are eager to extend their coverage to the third “screen”—the display of the handheld device.

What is needed is a system that allows a user of a handheld device to subsidize the cost of their handheld device while increasing advertiser's exposure on the third “screen”.

### BRIEF SUMMARY OF THE INVENTION

A first computing device communicates with a second computing device. The first computing device can be any computing device, including a cell phone. The second computing device can be any computing device, including a server. Also, the first computing device may communicate indirectly with the second computing device via a third computing device. The third computing device can be any computing device including a desktop computer.

The first computing device receives a media file play schedule from the second computing device. The media file play schedule has information corresponding to names of media files, play times for the media files, and credits associated with playing the media files. If the first computing device does not have some of the media files listed in the media file play schedule, the first computing device downloads the required media files. A scheduling engine running on the first computing device activates a play engine according to the media file play schedule. The play engine is also running on the first computing device. The play engine prompts a user associated with the first computing device that a media file is ready to play. The play engine responds to a first user input by signaling an application running on the first computing device to play the media file. After the media file has played, the play engine displays a second prompt indicating to the user that they can earn credits if they push a button on the first computing device. The play engine then monitors for a second input from the user and based on this second input, the play engine can make an entry in a play history file. A method, such as a timer countdown, can be used to filter the second input from the user and approximate if the user was attentive to the playing of the first media file. The play history file can be sent to the second computing device. The user can earn credits if they watch or listen to the media file that gets played.

Other objects, features and advantages of the present invention will become apparent upon perusal of the following description in conjunction with the appended drawings

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 illustrates an exemplary system for sending a play schedule and media files from a server to a first computing device. FIG. 1 also illustrates a play history sent from the first computing device to the server.

FIG. 2 illustrates an exemplary play schedule for media files and an exemplary play history.

FIG. 3 illustrates an exemplary system on a computing device for playing media files and recording user credits earned for playing the media files.

FIG. 4 illustrates an exemplary method that can be executed by a file transfer engine on a computing device.

FIG. 5 illustrates an exemplary method that can be executed by a scheduling engine on a computing device.

FIG. 6 illustrates an exemplary method for prompting a user, playing a media file and responding to the user's input.

FIG. 7 is a screen shot from a computing device illustrating prompting a user for input.

FIG. 8 is a screen shot from a computing device illustrating prompting a user for a second input.

### DESCRIPTION OF EMBODIMENTS

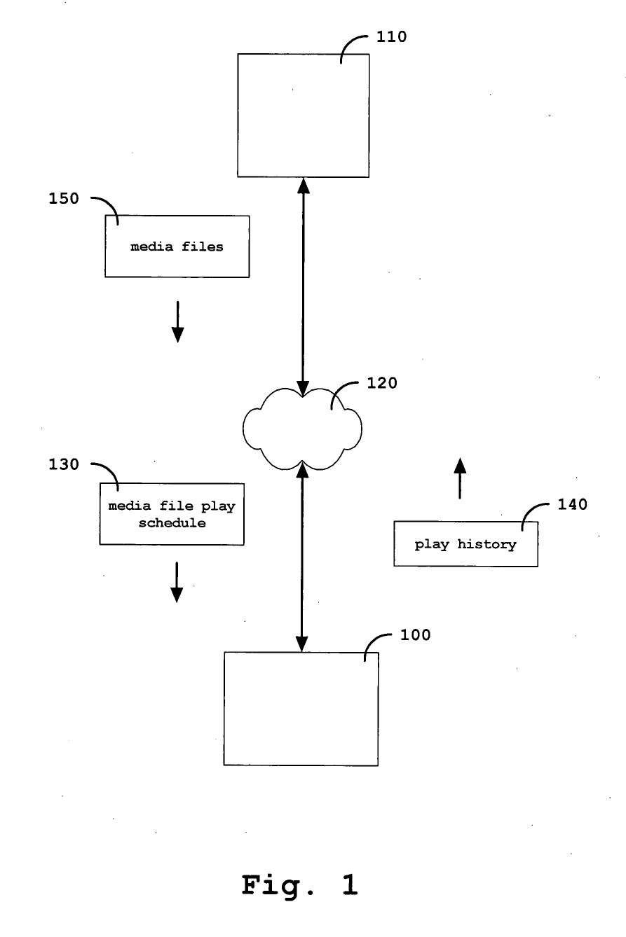

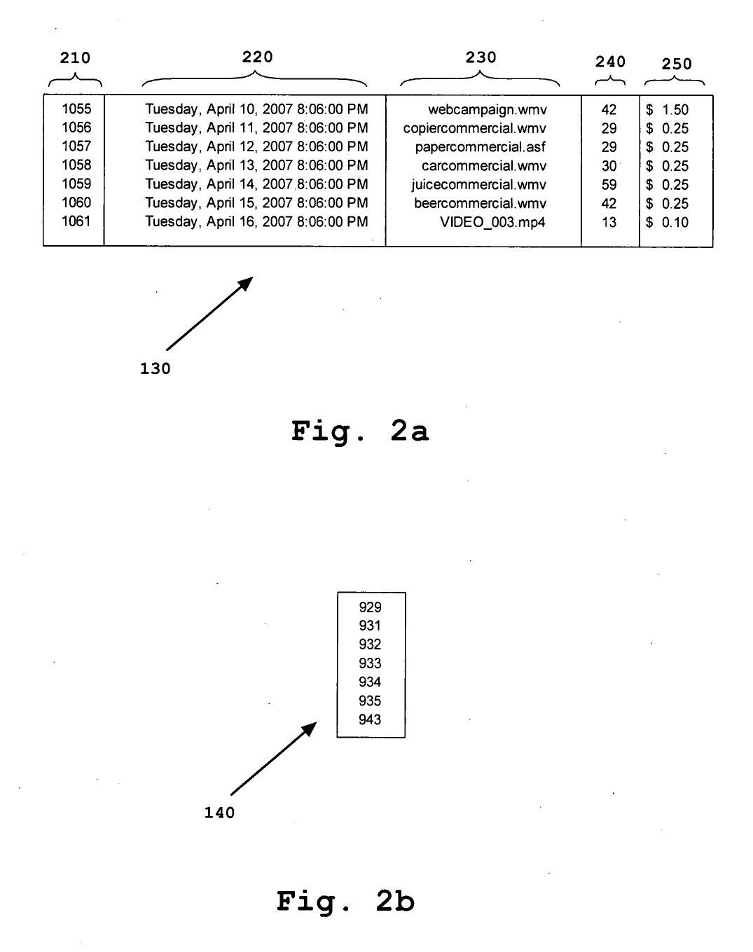

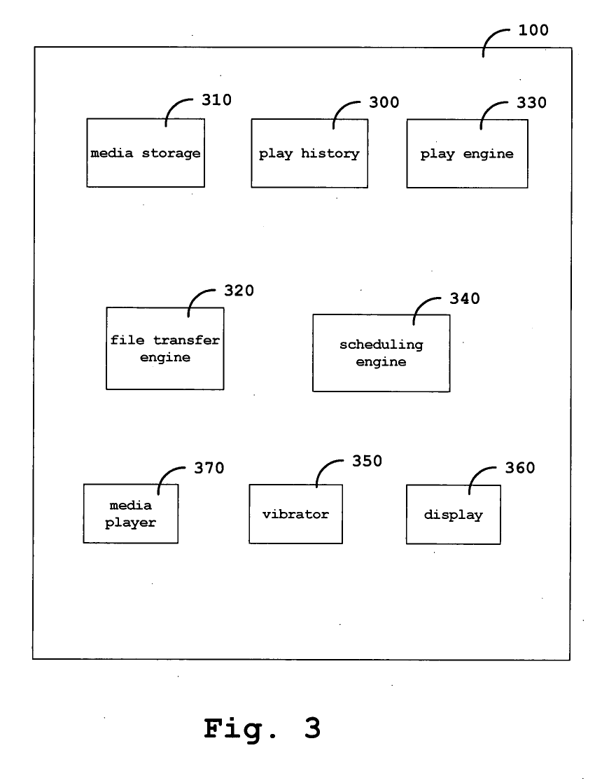

FIG. 1 illustrates a system where a first computing device 100 communicates with a second computing device 110 via a network 120. The first computing device 100 can be any suitable computing device examples of which include: cellphone, handheld, PDA, desktop computer, notebook computer and server. The second computing device 110 can also be any suitable computing device examples of which include: server, desktop computer, notebook computer, cellphone, handheld and PDA. The network 120 can be any suitable network such as the internet, wireless network and cellphone network. In addition, the first computing device 100 can access the network 120 by connecting to a third computing device (not shown) using a wired connector, such as a USB cable. The first computing device 100 receives a media file play schedule 130 via the network 120. An exemplary media file play schedule 130 is illustrated in FIG. 2a. The media file play schedule 130 can comprise transaction identifiers 210, play times 220, media file names 230, lengths 240 and credits 250. The exemplary media file play schedule 130 in FIG. 2a shows detailed play times for the media files 150. This is not a requirement, more generalized scheduling can be indicated in the media file play schedule 130 such as “evenings” or “weekends”. More precise scheduling can be provided by the scheduling engine 340 (discussed later in regards to FIG. 3) on the first computing device 100.

Referring again to FIG. 1, the first computing device 100 can receive media files 150 from the second computing device 110. The media files 150 can be audio files, video files or any other type of media files. The first computing device 100 can send a play history 140 to the second computing device 110. An exemplary play history 140 is illustrated in FIG. 2b. The play history 140 can comprise transaction identifiers 210.

FIG. 3 illustrates a functional block diagram of an exemplary system on a first computing device 110. The functional blocks can be implemented using software or hardware or a combination of software and hardware. In addition, the system can be implemented as one application or as several applications working together. 300 is a play history database, 310 is a media file storage, 320 is a file transfer engine, 330 is a play engine, 340 is a scheduling engine, 350 is a vibrator, 360 is a display and 370 is a media player.

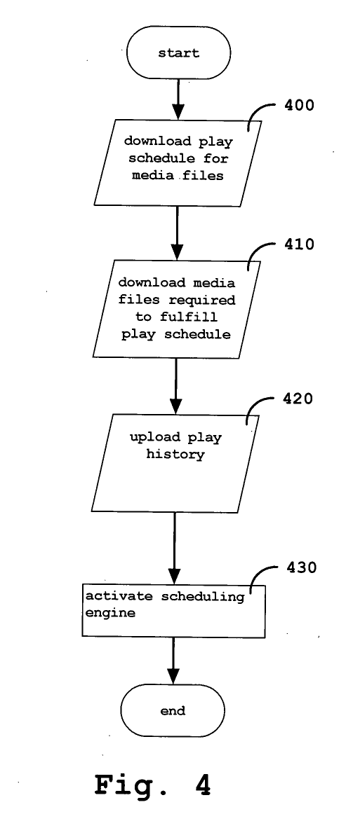

The play history database 300 stores the play history 140. 310 is the media storage where media files 150 can be stored on the first computing device 100. The vibrator 350 can be activated to alert a user (not shown) associated with the first computing device 100. 320 is the file transfer engine. The file transfer engine 320 can be a software module that handles sending the play history 140 to the second computing device 110. The file transfer engine 320 can also operate to receive the media file play schedule 130 and the media files 150 for the first computing device 100. FIG. 4 illustrates an exemplary method that can be performed by the file transfer engine 320. In block 400, the file transfer engine 320 receives the media file play schedule 130. At block 410, the file transfer engine 320 checks if any media files referred to in the play schedule 130 are missing from the first computing device 100. If required, the file transfer engine 320 receives the necessary media files 150 from the second computing device 110 and stores them in the media storage 310. In block 420, the file transfer engine 320 can send the play history 140 to the second computing device 110. In block 430, the file transfer engine can activate the scheduling engine 340.

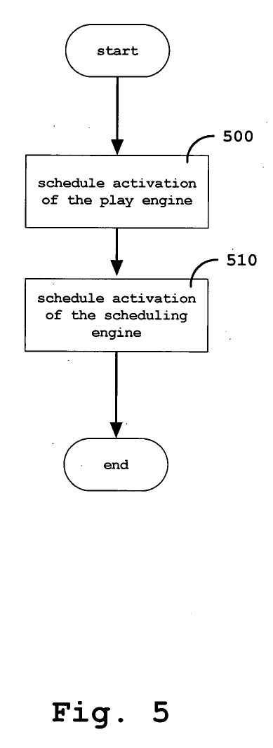

The scheduling engine 340 in FIG. 3 can implement an exemplary method as illustrated in FIG. 5. In block 500, the scheduling engine 340 can schedule the activation of the play engine 330. In block 500, there can be single or multiple activations of the play engine 330 scheduled. The scheduling engine 340 can use precise scheduling information from the media file play schedule 130. The scheduling engine 340 may also adjust the scheduled activation of the play engine 330 such that is different than the scheduling information in the media file play schedule 130. In block 510 of the exemplary method illustrated in FIG. 5, the scheduling engine 340 may schedule the activation of itself.

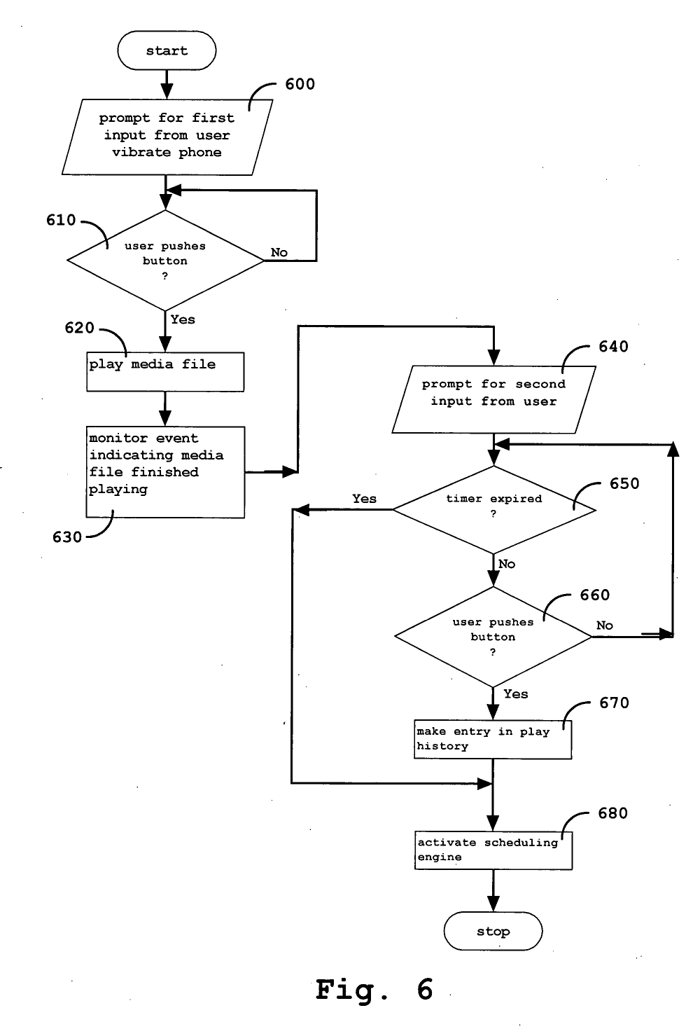

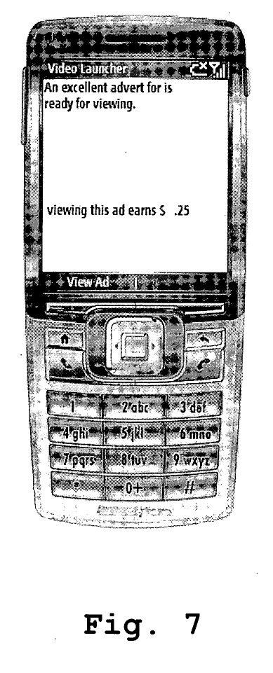

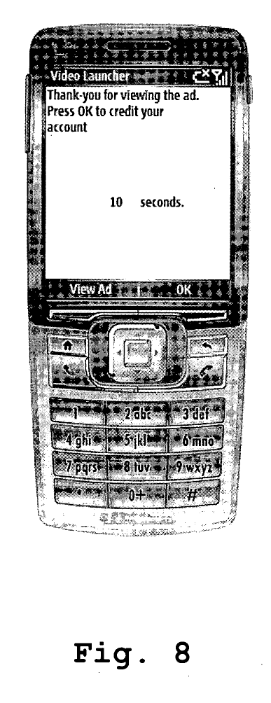

The play engine 330 in FIG. 3 can implement an exemplary method as illustrated in FIG. 6. In block 600, the play engine 330 can prompt a user (not shown) associated with the first computing device 100 for a first input by vibrating the first computing device 100 and displaying a first message on the display 360 of the first computing device 100. FIG. 7 illustrates what the display 360 might look like when block 600 is executed. The example in FIG. 7 shows that the user would earn $0.25 for viewing this particular media file 150. Also in block 600 before showing a prompt, the computing device 100 may be set to an increased power state. An example of setting the computing device to an increased power state would be to increase the brightness of a backlight associated with the display 360. In block 610, a user input can be monitored on an event driven basis, and if the first input from the user is detected, the method continues at block 620. At block 620, the play engine 330 can instruct the media player 370 to play a first media file 150. The play engine 330 may need to examine the media file play schedule 130 to determine which media file 150 to play. Also at block 620, the first media file 150 can be in the media storage 310 on the first computing device 100 or the first media file 150 can be streamed to the first computing device 100. The method continues with block 630 where an event can be monitored such as a timer expiry or a signal from the media player 370 that the playing of the first media file 150 is complete. At block 640 a second message is displayed on the display 360. FIG. 8 illustrates what the display 360 may look like when block 640 is executed. The example of FIG. 8 indicates that the user must press the ‘OK’ button within ten seconds in order to have their account credited. Blocks 650 and 660 represent that a timer (not shown) is monitored and an input of the computing device 100 is monitored. If there is a second input from the user to the computing device 100 before the timer (not shown) expires the method continues to block 670. This provides a clue that the user has been attentive to the playing of the first media file 150. If there is not a second input from the user to the computing device 100 before the timer (not shown) expires, the method continues at block 680. In block 670 an entry is made in the play history database 300 that corresponds to the user acknowledging the play of the first media file 150. The entry in the play history database 300 can be as simple as a transaction identifier as illustrated in FIG. 2b. The method continues with block 680 where the scheduling engine 340 is activated. Block 680 of the method may be required because on some computing devices the scheduling engine 340 may only be able to schedule a single activation of the play engine 330 at a time, thus requiring the play engine 330 and the scheduling engine 340 to alternately activate each other.

The scheduling engine 340 examines the media file play schedule 130 and activates the play engine at times corresponding to the media file play schedule 130.

Referring again to FIG. 6, when the first media file 150 is played in block 620, indicia such as graphics or text can be displayed on the display 360. Then in block 660, rather than just pushing a button, the user can make an entry corresponding to the displayed indicia in order to get a “Yes” result. This can help more accurately determine if the user (not shown) has paid attention to the playing of the first media file 150. For instance, while the media file 150 is playing, the text segment “abc” could be displayed superimposed on the display 360. Then, in block 660 the user must enter “abc” in order to earn the credits 250 associated with the first media file 150. Other possibilities might include the user (not shown) entering an answer to a question regarding the first media file 150.

Many alternative embodiments to the above described methods and systems are possible. In an alternative embodiment, block 600 and block 610 of the method illustrated in FIG. 6 are not implemented by the play engine 330. In this alternative embodiment, the playing of the media file 150 is done on a scheduled basis. While various embodiments have been described above, it should be understood that it has been presented by way of example only, and not limitation.

We claim:

1. A method implemented on a first computing device having a display, the first computing device associated with a user, the method comprising:
according to a schedule, prompting for a first input from the user;
responding to the first input from the user by instructing an application on the first computing device to play a first media file; and
responding to a second input from the user by making an entry in a play history database.

2. The method of claim 1 further comprising obtaining the schedule from a second computing device.

3. The method of claim 1 further comprising obtaining media files from a second computing device.

4. The method of claim 1 where the media files are one of audio files and video files.

5. The method of claim 1 further comprising sending information corresponding to information stored in the play history database to a second computing device.

6. The method of claim 1 wherein prompting for the first input from the user comprises at least one of vibrating the first computing device, causing the first computing device to make a sound, displaying text on the display, and displaying graphics on the display.

7. The method of claim 1 further comprising displaying a message on the display in response to an event associated with the playing of the first media file.

8. The method of claim 7 where the event corresponds to a notification from an application that played the first media file.

9. The method of claim 7 where the event corresponds to a timer expiry.

10. The method of claim 1 wherein making an entry in the play history database comprises making an entry in the play history database that corresponds to the user acknowledging the playing of the first media file.

11. The method of claim 1 wherein making an entry in the play history database comprises making an entry in the play history database that corresponds to the user not acknowledging the playing of the first media file.

12. The method of claim 1 wherein if the user provides a second input that satisfies a first criteria then making an entry in the play history database comprises making an entry in the play history database where the entry corresponds to the user acknowledging the playing of the first media file.

13. The method of claim 12, wherein the first criteria is that the second input from the user is received within a predetermined time period.

14. The method of claim 12, wherein the first criteria is that the second input from the user corresponds to indicia displayed on the display.

15. The method of claim 12, wherein the first criteria is that the second input from the user corresponds to an aspect of the first media file.

16. The method of claim 1 wherein if the user does not provide a second input that satisfies a first criteria then making an entry in the play history database comprises making an entry in the play history database where the entry corresponds to the user not acknowledging the playing of the first media file.

17. The method of claim 1 wherein if the user does not provide a second input that satisfies a first criteria then no entry is made in the play history database.

18. The method of claim 1 where prior to prompting for the first input from the user, the first computing device is set to an increased power state.

19. The method of claim 16 wherein the first computing device is set to an increased power state comprises increasing the brightness of a backlight.

20. The method of claim 1 wherein prompting for a first input from the user according to a schedule, the schedule originates from a second computing device and is transferred to the first computing device.

21. A method implemented on a first computing device having a display, the first computing device associated with a user, the method comprising:
according to a schedule, instructing an application on the first computing device to play a first media file; and
responding to an input from the user by making an entry in a play history database, wherein the input from the user is associated with the playing of the first media file.

22. The method of claim 21 where if the input from the user satisfies a first criteria then making an entry in the play history database comprises making an entry in the play history database where the entry corresponds to the user acknowledging the playing of the first media file.

23. The method of claim 22, wherein the first criteria is that the input from the user is received within a predetermined time period.

24. A method of detecting a computer user's notice of the playing of a media file, the method comprising:
receiving an input from the computer user within a predetermined time period associated with the playing of the media file, where the predetermined time period starts after the playing of the media file begins.

25. A system on a first computing device having a display, the first computing device associated with a user, the system comprising:
a play history database that can store information corresponding to a play history for media files;
a file transfer engine that can send information from the play history database to a second computing device, that can also obtain a schedule from the second computing device, and that can also obtain media files from the second computing device;
a play engine that can prompt for a first input from the user, respond to the first input by playing a first media file or instructing an application to play the first media file, respond to an event by displaying a message, respond to a second user input by storing information in the play history database, the information corresponding to the playing of the first media file; and
a scheduling engine that activates the play engine according to the schedule.
